(19) United States
(12) Patent Application Publication
(10) Pub. No.: US 2007/0225159 A1
(43) Pub. Date: Sep. 27, 2007

(54) Exhaust Gas Purifying Catalyst and Production Process Thereof

(75) Inventors: Masaya Ibe, Shizuoka (JP); Masahide Miura, Shizuoka (JP)

Correspondence Address: OLIFF & BERRIDGE, PLC, P.O. BOX 19928, ALEXANDRIA, VA, 22320, US

(73) Assignee: Toyota Jidosha Kabushiki Kaisha, Aichi (JP)

(21) Appl. No.: 11/629,383

(22) PCT Filed: Aug. 4, 2005
(86) PCT No.: PCT/JP05/14707

§ 371 Date: Dec. 13, 2006

(30) Foreign Application Priority Data
Aug. 9, 2004 (JP) 2004-232299

(51) Int. Cl. B01J 23/40; B01D 53/94; B01J 23/63

(52) U.S. Cl. 502/304; 502/300; 502/349

(57) ABSTRACT

The present invention relates to an exhaust gas purifying catalyst comprising first and second metal oxide supports and a noble metal supported thereon, wherein the first and second metal oxide supports both have a primary particle diameter of less than 100 nm, primary particles of the first and second metal oxide supports are mixed with each other, and the amount of the noble metal supported per unit surface area of the first metal oxide support is larger than the amount of the noble metal supported per unit surface area of the second metal oxide support. Further, the present invention relates to a production process of the exhaust gas purifying catalyst.

### TECHNICAL FIELD

The present invention relates to an exhaust gas purifying catalyst, for purifying the components in an exhaust gas discharged from a combustion apparatus such as internal combustion engine, and a production process for the exhaust gas purifying catalyst.

### RELATED ART

The exhaust gas from an internal combustion engine such as an automobile engine contains nitrogen oxide (NOₓ), carbon monoxide (CO), hydrocarbon (HC) and the like, and these substances can be removed by an exhaust gas purifying catalyst for oxidizing CO and HC and, at the same time, reducing NOₓ. As for representative exhaust gas purifying catalysts, three-way catalysts, where a noble metal such as platinum (Pt), rhodium (Rh) and palladium (Pd) is supported on a porous metal oxide support such as γ-alumina, are known.

With respect to such an exhaust gas purifying catalyst, various studies are being made, and a technique of mixing or stacking multiple species of metal oxide supports to utilize the characteristic properties of the respective metal oxide supports is also practiced. For example, ceria has an oxygen storage capacity (OSC) of storing oxygen when the oxygen concentration in the exhaust gas is high, and releasing oxygen when the oxygen concentration in the exhaust gas is low, but it has a relatively low heat resistance. Accordingly, ceria is solid-dissolved or mixed with zirconia or alumina to improve heat resistance of the catalyst.

Furthermore, when mixtures of multiple species of metal oxide supports are used, it is also proposed to load different catalyst metals on respective metal oxide supports. For example, Japanese Unexamined Patent Publication (Kokai) No. 11-267503 discloses a catalyst obtained by mixing a first catalyst powder having a noble metal supported thereon and a second catalyst powder having an NOₓ-storing material and a base metal supported thereon. According to this document, sintering of noble metal can be prevented by disposing a noble metal and an NOₓ-storing material separatedly from each other and, at the same time, oxidation-reduction of NOₓ can be accelerated by loading a base metal and an NOₓ-storing material in proximity.

Japanese Unexamined Patent Publication (Kokai) No. 10-202108 proposes to load a noble metal on a catalyst support by using an organic noble metal complex. According to this document, a first neighbor atom to an active noble metal atom can be the same noble metal atom as the active noble metal atom.

Japanese Unexamined Patent Publication (Kokai) No. 11-246901 proposes to produce fine metal particles in a polyhydric alcohol and prevent aggregation of fine metal particles by adjusting the pH to 2 or less or 7 or more.

Japanese Unexamined Patent Publication (Kokai) No. 11-192432 proposes to use a noble metal cluster carbonyl compound in which the total electric charge n of the noble metal carbonyl complex is from −1 to −10.

As described above, it is known to use multiple species of metal oxide supports, for example, ceria and alumina supports, in combination, and to thereby obtain the benefits of respective supports.

Also, according to studies in recent years, it has been found that the combination of a metal oxide support and a noble metal supported thereon has an important value. For example, when platinum is supported on ceria, sintering of platinum is prevented by virtue of affinity of platinum for ceria, and when rhodium is supported on zirconia, a good exhaust gas purifying performance is exerted. If platinum is sintered during use of a catalyst, active sites of the catalyst decrease and then the catalytic activity is deteriorated. Therefore, it is very important to prevent sintering of platinum.

### DISCLOSURE OF THE INVENTION

The present invention provides an exhaust gas purifying catalyst comprising multiple species of metal oxide supports and successfully exerts the properties of these metal oxide supports and also provides a production process of the exhaust gas purifying catalyst.

The exhaust gas purifying catalyst of the present invention is an exhaust gas purifying catalyst comprising first and second metal oxide supports and a noble metal supported thereon, wherein the first and second metal oxide supports both have a primary particle diameter of less than 100 nm, preferably less than 50 nm, more preferably less than 20 nm, still more preferably less than 15 nm, and most preferably less than 10 nm; primary particles of the first and second metal oxide supports are mixed with each other; and the amount of the noble metal supported per unit surface area of the first metal oxide support is larger than the amount of the noble metal supported per unit surface area of the second metal oxide support, preferably by 50% or more, more preferably by 100% or more, still more preferably by 500% or more, or particularly, the noble metal is supported substantially only on the first metal oxide support.

According to the exhaust gas purifying catalyst of the present invention, the amount of the noble metal supported per unit surface area of the first metal oxide support is larger than the amount of the noble metal supported per unit surface area of the second metal oxide support, so that interaction between the first metal oxide support and the noble metal can successfully appear. Furthermore, the first and second metal oxide supports have a small primary particle diameter and the primary particles of first and second metal oxide supports are mixed with each other, so that the effect of the combination of first and second metal oxide supports can be successfully obtained. Incidentally, the exhaust gas purifying catalyst of the present invention may further comprise a metal oxide support other than the first and second metal oxide supports.

In one embodiment of the present invention, the first and second metal oxide supports may form a secondary particle of less than 100 nm.

In one embodiment of the exhaust gas purifying catalyst of the present invention, the first metal oxide support is ceria, the second metal oxide support is alumina or zirconia, and the noble metal is platinum.

According to this embodiment, sintering of platinum can be prevented by loading platinum on ceria and at the same time, sintering of ceria can be prevented by mixing the alumina or zirconia primary particle with the ceria primary particle.

In one embodiment of the exhaust gas purifying catalyst of the present invention, the first metal support is zirconia, the second metal oxide support is alumina or ceria, and the noble metal is rhodium.

According to this embodiment, good catalytic activity of rhodium supported on zirconia can be utilized and at the same time, the OSC attributable to ceria or sintering-prevention effect or the like attributable to alumina can be achieved.

The process of the present invention is a process for producing an exhaust gas purifying catalyst, comprising the following (a) to (d):

(a) providing a first sol containing first metal oxide colloidal particles, and a second sol containing a second metal oxide colloidal particle,

(b) adding a first noble metal solution containing a first noble metal ion or complex ion to the first sol to load a first noble metal on the first metal oxide colloidal particles,

(c) mixing the first sol, to which the noble metal solution has been added, with the second sol to prepare a mixed sol, and

(d) drying and firing the resulting mixed sol.

According to the process of the present invention, a noble metal is loaded on a population of colloidal particles and, thereafter, this population of particles is mixed with another population of colloidal particles in a liquid, so that, in an exhaust gas purifying catalyst obtained, particles having a small primary particle diameter of, for example, less than 20 nm are mixed with each other and at the same time, the noble metal is supported selectively on one support. Incidentally, other metal oxide support may be further present in this catalyst.

In one embodiment, the process of the present invention may comprise the following step: (b′) adding a second noble metal solution containing a second noble metal ion or complex ion to the second sol to load a second noble metal on the second metal oxide colloidal particles.

According to this embodiment, in an exhaust gas purifying catalyst obtained, it is further possible for a second noble metal to be supported on the second meal oxide support.

### BRIEF DESCRIPTION OF THE DRAWINGS

FIG. 1a is a conceptual view for explaining the exhaust gas purifying catalyst of the present invention.

FIGS. 1b and 1c are conceptual views for explaining conventional exhaust gas purifying catalysts.

FIG. 2 is a view showing change of the zeta potential of colloidal particles due to a change in the pH of solution.

FIG. 3 is a graph showing performance of exhaust gas purifying catalysts of Example 1 and Comparative Example 1.

FIG. 4 is a graph showing performance of exhaust gas purifying catalysts of Example 2 and Comparative Example 2.

FIG. 5 is a graph showing performance of exhaust gas purifying catalysts of Example 3 and of Comparative Example 3.

### BEST MODE FOR CARRYING OUT THE INVENTION

The exhaust gas purifying catalyst of the present invention and the production process thereof are described below by referring to the drawings, but the present invention is not limited thereto.

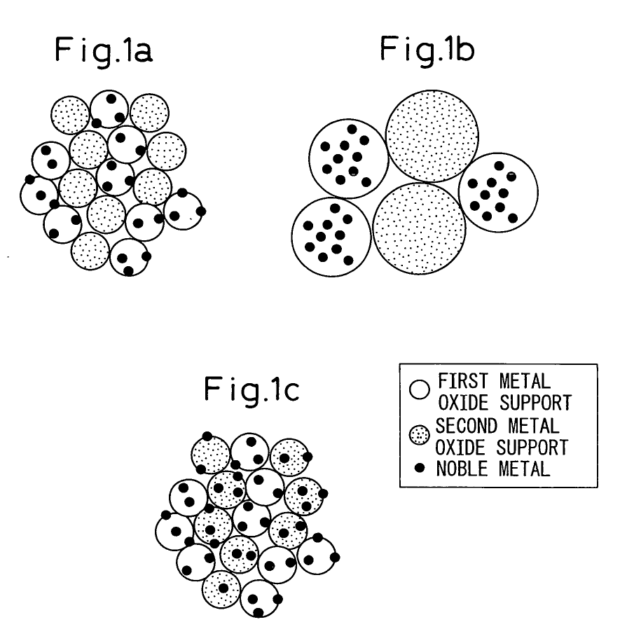

In the exhaust gas purifying catalyst of the present invention, as shown in FIG. 1a, relatively small primary particles of first and second metal oxide supports (for example, CeO₂ and Al₂O₃) are mixed with each other.

On the other hand, in a conventional exhaust gas purifying catalyst obtained by loading a noble metal (for example, Pt) on a first metal oxide support powder, drying and firing this powder, and mixing it with a second metal oxide support powder, as shown in FIG. 1b, respective primary particles generally have a relatively large particle diameter or in some cases, the first and second metal oxide supports are not satisfactorily mixed. Also, when a support is produced by drying and firing a sol containing first and second metal oxide colloidal particles and a noble metal is loaded thereon in a conventional manner with use of a strongly acidic or strongly alkaline noble metal solution, in the exhaust gas purifying catalyst obtained, as shown in FIG. 1c, the noble metal is supported substantially equally on the first and second metal oxide supports.

The process of the present invention is described in detail below.

The first and second metal oxide colloidal particles which can be used in the process of the present invention are, for example, colloidal particles of a metal oxide selected from the group consisting of ceria, zirconia, alumina, titania and silica. These colloidal particles have a particle diameter of, for example, less than 100 nm, less than 50 nm, less than 20 nm, less than 15 nm, or less than 10 nm. The medium in which the colloidal particles are dispersed may be any liquid suitable for mixing with a noble metal solution to load a noble metal on the colloidal particle, such as water.

The noble metal solution usable in the present invention may be any metal solution, particularly, a noble metal nitrate or complex solution containing a noble metal complex ion. The noble metal may be, for example, platinum, rhodium or palladium, and the noble metal complex ion is, for example, tetranitroplatinum (Pt(NO₂)₄²⁻), hexanitroplatinum (Pt(NO₂)₆⁴⁻) or hexaammine rhodium (Rh (NH₃)₆³⁺).

The drying and firing of the colloidal particle having supported thereon a noble metal may be performed by any method at any temperature. For example, the drying may be achieved by placing the mixed sol in an oven at 120° C. The dried product after such drying is fired, whereby an exhaust gas purifying catalyst can be obtained. This firing may be performed at a temperature generally employed in the synthesis of metal oxides, for example, at a temperature of 300 to 1,100° C.

The exhaust gas purifying catalyst of the present invention may be produced by any method but can be produced particularly by the process of the present invention.

Further, the exhaust gas purifying catalyst of the present invention can be produced by selectively loading a noble metal by utilizing the difference in the zeta potential between first and second colloidal particles in a solution. That is, for example, a sol containing first and second colloidal particles which differ with each other in the mode of change of the zeta potential due to change of the pH value is prepared. A noble metal solution containing a noble metal ion or complex ion is added to this solution, while adjusting the pH of the sol so that the noble metal ion or complex ion is electrostatically drawn to the first colloidal particle. Finally, the sol is dried and fired.

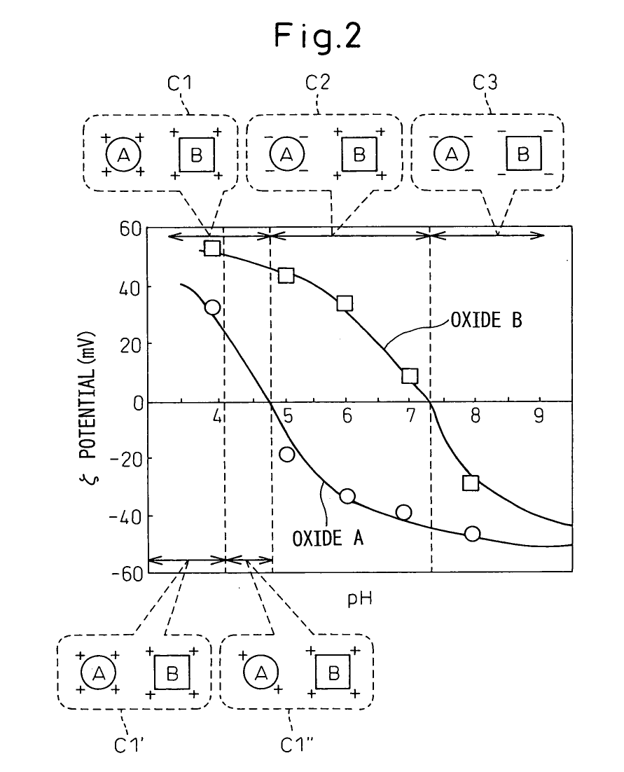

In order to cause the noble metal ion or complex ion to be electrostatically drawn to the first colloidal particle, for example, the pH of the solution is adjusted to a pH where the zeta potential of the first colloidal particle has a sign (positive or negative) different from the sign of zeta potential of the second colloidal particle as well as from the sign of electric charge of the noble metal ion or complex ion, that is, to a pH range shown by C2 in FIG. 2.

Even when the zeta potential of the first colloidal particle has the same sign as that of the zeta potential of the second colloidal particle, the noble metal ion or complex ion can be caused to be electrostatically drawn to the first colloidal particle by controlling these zeta potentials to differ in the magnitude, that is, adjusting the pH to, for example, a pH range shown by C1″ in FIG. 2.

The present invention is described below by referring to Examples, but the present invention is not limited to the Examples.

### EXAMPLES

### Example 1

A dinitrodiamine platinum (Pt(NO₂)₂(NH₃)₂) solution was added to an acid-stabilized aqueous ceria sol solution (colloidal particle diameter: 10 nm, isoelectric point: pH 8.5) to give a platinum content of 1 wt % based on ceria. Separately, a hexaammine rhodium (Rh(NH₃)₆³⁺) solution was added to an alkali-stabilized aqueous zirconia sol solution (colloidal particle diameter: 30 nm, pH at isoelectric point: 3.5) to give a rhodium content of 0.5 wt % based on zirconia. Thereafter, these solutions were mixed to cause precipitation (ceria:zirconia (molar ratio)=3:2). The resulting solution was dried at 120° C. for 24 hours and fired at 700° C. for 5 hours to obtain a catalyst powder. For the evaluation of catalyst activity, the obtained catalyst powder was shaped into 1 mm-square pellets.

### Comparative Example 1

A ceria powder (particle diameter: 10 μm) was impregnated with a dinitrodiamine platinum solution and fired at 500° C. for 2 hours, thereby loading platinum to a platinum content of 1 wt % based on the ceria. Separately, a zirconia powder (particle diameter: 15 μm) was impregnated with a rhodium chloride solution and fired at 500° C. for 2 hours, thereby loading rhodium to a rhodium content of 0.5 wt % based on the zirconia. The obtained ceria powder and zirconia powder were mixed in a mortar (ceria:zirconia (molar ratio)=3:2). For the evaluation of catalyst activity, the obtained catalyst powder was shaped into 1 mm-square pellets.

### Performance Evaluation of Catalysts of Example 1 and Comparative Example 1

The catalyst pellets were fired at 900° C. for 5 hours in air. Thereafter, a rich gas and a lean gas each having the composition shown in Table 1 below were alternately passed to the catalyst pellets at a cycle of 1 Hz, and by elevating the temperature of these rich/lean gases, the temperatures where the purification ratios of HC, CO and NO reached 50% (50% purification temperature) were examined.

TABLE 1
Composition of Evaluation Gas

| | N₂ | CO₂ | NO | CO | C₃H₆ | H₂ | O₂ | H₂O |
|---|---|---|---|---|---|---|---|---|
| | (%) | (%) | (ppm) | (%) | (ppmC) | (%) | (%) | (%) |
| Rich | balance | 10 | 2200 | 2.80 | 2500 | 0.27 | 0.77 | 10 |
| gas | | | | | | | | |
| Lean | balance | 10 | 2200 | 0.81 | 2500 | 0 | 1.7 | 10 |
| gas | | | | | | | | |

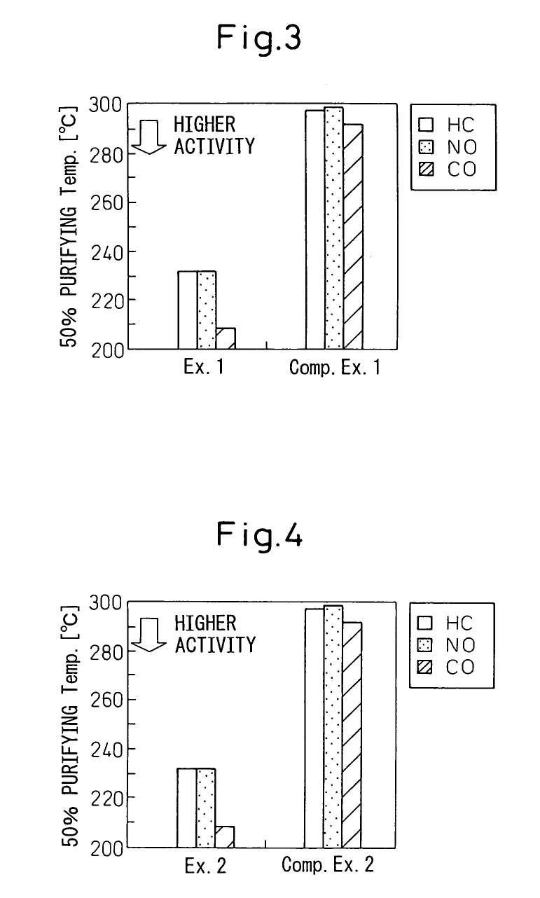

FIG. 3 shows the obtained 50% purification temperatures. As apparent from FIG. 3, for all of HC, CO and NO, the catalyst of Example 1 exhibited a 50% purification temperature lower than that of Comparative Example 1. This reveals that the catalyst of Example 1 exerts good activity from a relatively low temperature as compared with the catalyst of Comparative Example 1.

### Example 2

While adjusting the pH of an alkali-stabilized aqueous zirconia sol solution (isoelectric point: pH 3.5) to 5, an acidic-stabilized aqueous ceria sol solution (isoelectric point: pH 8.5) and a tetranitroplatinum (Pt(NO₂)₄²⁻) solution were added thereto (CeO₂:ZrO₂=1:1 (molar ratio), platinum content: 1 wt % based on the total of ceria and zirconia). The resulting solution was dried at 120° C. for 24 hours and the dried product was fired at 700° C. for 5 hours to obtain a catalyst powder. For the evaluation of catalyst activity, the obtained catalyst powder was shaped into 1 mm-square pellets.

### Comparative Example 2

A catalyst powder was obtained in the same manner as in Example 2 except for not adjusting the pH. Incidentally, the pH of the liquid dispersion was about 2 after adding the tetranitroplatinum solution to the mixed sol. For the evaluation of catalyst activity, the obtained catalyst powder was shaped into 1 mm-square pellets.

### Performance Evaluation of Catalysts of Example 2 and Comparative Example 2

The 50% purification temperatures for HC, CO and NO were examined in the same manner as in Example 1 and Comparative Example 1. However, the catalysts were fired at 900° C. for 3 hours in air before the examination.

FIG. 4 shows the obtained 50% purification temperatures. As apparent from FIG. 4, for all of HC, CO and NO, the catalyst of Example 2 exhibited a 50% purification temperature lower than that of Comparative Example 2. This reveals that the catalyst of Example 2 exerts good activity from a relatively low temperature as compared with the catalyst of Comparative Example 2.

### Example 3

While adjusting the pH of an acidic-stabilized aqueous ceria sol solution (isoelectric point: pH 8.5) to 6, an alkali-stabilized aqueous zirconia sol solution (isoelectric point: pH 3.5) and a hexaammine rhodium (Rh(NH₃)₆³⁺) solution were added thereto (ZrO₂:CeO₂=1:1 (molar ratio), rhodium content: 1 wt % based on the total of ceria and zirconia). The resulting solution was dried at 120° C. for 24 hours and the dried product was fired at 700° C. for 5 hours to obtain a catalyst powder. For the evaluation of catalyst activity, the obtained catalyst powder was shaped into 1 mm-square pellets.

### Comparative Example 3

A catalyst powder was obtained in the same manner as in Example 3 except for not adjusting the pH. Incidentally, the pH of the mixed sol was about 9 after adding the hexaammine rhodium solution to the mixed sol. For the evaluation of catalyst activity, the obtained catalyst powder was shaped into 1 mm-square pellets.

### Performance Evaluation of Catalysts of Example 3 and Comparative Example 3

The 50% purification temperatures for HC, CO and NO were examined in the same manner as in Example 2 and Comparative Example 2.

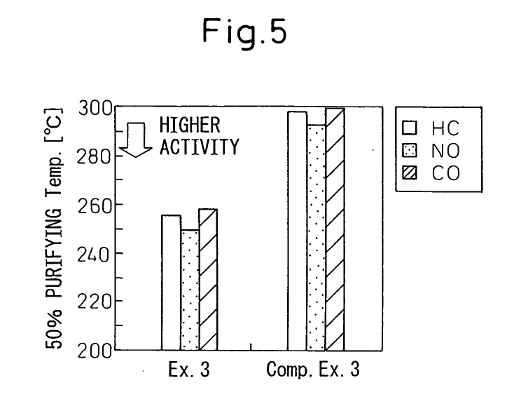

FIG. 5 shows the obtained 50% purification temperatures. As is apparent from FIG. 5, for all of HC, CO and NO, the catalyst of Example 3 exhibited a 50% purification temperature lower than that of Comparative Example 3. This reveals that the catalyst of Example 3 exerts good activity from a relatively low temperature as compared with the catalyst of Comparative Example 3.

1. An exhaust gas purifying catalyst powder comprising first and second metal oxide supports and a noble metal supported thereon, wherein said first and second metal oxide supports both have a primary particle diameter of less than 100 nm, primary particles of said first and second metal oxide supports are mixed with each other, and the amount of said noble metal supported per unit surface area of said first metal oxide support is larger than the amount of said noble metal supported per unit surface area of said second metal oxide support.

2. The exhaust gas purifying catalyst powder according to claim 1, wherein said first and second metal oxide supports form a secondary particle of less than 100 nm.

3. The exhaust gas purifying catalyst powder according to claim 1, wherein said first metal oxide support is ceria, said second metal oxide support is alumina or zirconia, and said noble metal is platinum.

4. The exhaust gas purifying catalyst powder according to claim 1, wherein said first metal oxide support is zirconia, said second metal oxide support is alumina or ceria, and said noble metal is rhodium.

5. A process for producing an exhaust gas purifying catalyst powder, comprising:
a) providing a first sol containing first metal oxide colloidal particles, and a second sol containing second metal oxide colloidal particles,
b) adding a first noble metal solution containing a first noble metal ion or complex ion to said first sol to load a first noble metal on the first metal oxide colloidal particles,
c) mixing the first sol, to which said noble metal solution has been added, with the second sol to prepare a mixed sol, and
d) drying and firing the resulting mixed sol.

6. The process according to claim 5, which comprises the following step:
(b′) adding a second noble metal solution containing a second noble metal ion or complex ion to said second sol to load a second noble metal on the second metal oxide colloidal particles.

7. The exhaust gas purifying catalyst powder according to claim 2, wherein said first metal oxide support is ceria, said second metal oxide support is alumina or zirconia, and said noble metal is platinum.

8. The exhaust gas purifying catalyst powder according to claim 2, wherein said first metal oxide support is zirconia, said second metal oxide support is alumina or ceria, and said noble metal is rhodium.
